(19) United States
(12) Patent Application Publication
(10) Pub. No.: US 2003/0208689 A1
(43) Pub. Date: Nov. 6, 2003

(54) Remote computer forensic evidence collection system and process

(76) Inventor: Joel De La Garza, Palo Alto, CA (US)

Correspondence Address: GLENN PATENT GROUP, 3475 EDISON WAY, SUITE L, MENLO PARK, CA, 94025, US

(21) Appl. No.: 09/800,378

(22) Filed: Mar. 5, 2001

Related U.S. Application Data
(60) Provisional application No. 60/212,126, filed on Jun. 16, 2000.

(51) Int. Cl. G06F 11/30

(52) U.S. Cl. 713/201

(57) ABSTRACT

A remote computer forensic evidence collection system is provided that allows incident response professionals to collect client data remotely while adhering to strict evidentiary standards by automatically verifying the content received with the data from the victim machine.

### BACKGROUND OF THE INVENTION

1. Technical Field

The invention relates to computer security. More particularly, the invention relates to a remote computer forensic evidence collection system and process.

2. Description of the Prior Art

Incident response as a business has one key barrier to entry. For a security incident to be investigated thoroughly, and to have the evidence collected in such a manner that it can be admissible in court, incident response professionals are forced to visit the scene of the incident so that they can perform a collection of data. The data are rarely processed on site however. The data are usually stored on a disk and transported, by the incident response professional, back to a clean environment where it can be examined and documented.

It would be desirable to provide a remote computer forensic evidence collection system that would allow incident response professionals to collect client data remotely while adhering to strict evidentiary standards by automatically verifying the content received with the data from the victim machine.

Unfortunately, it is not currently known to provide such approach to forensic evidence collection because the size of the files in which the data of interest are contained is on the order of 20+ gigabytes. Until recently, the bandwidth to move 20+ gigabytes of data did not exist.

More importantly, no one has thought about solving this problem because most incident response teams are in-house and do not have a need to travel to a client site. Thus, incident Reponses and forensic evidence collection is currently an immature market, i.e. computer security as a market is still in it's infancy, incident response as a part of that market is even less mature.

### SUMMARY OF THE INVENTION

A remote computer forensic evidence collection system is provided that allows incident response professionals to collect client data remotely while adhering to strict evidentiary standards by automatically verifying the content received with the data from the victim machine.

### BRIEF DESCRIPTION OF THE DRAWINGS

FIG. 1 is a flow diagram of a remote computer forensic collection system and process according to the invention.

### DETAILED DESCRIPTION OF THE INVENTION

The invention provides a remote computer forensic evidence collection system that allows incident response professionals to collect client data remotely while adhering to strict evidentiary standards by automatically verifying the content received with the data from the victim machine.

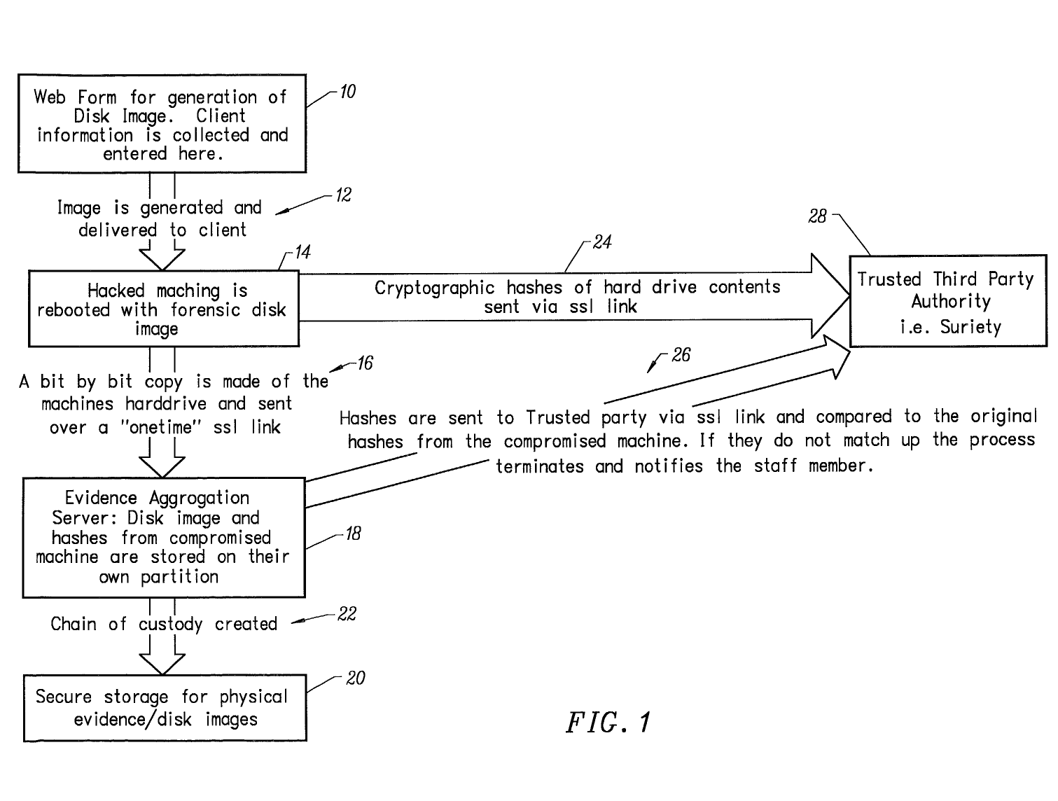

FIG. 1 is a flow diagram of a remote computer forensic collection system and process according to the invention.

System Components

The system comprises a secure server containing the forensic evidence aggregator 18, an image generation system, and a bootable image containing the forensic evidence collection suite 14.

The image generation system is preferably a set of scripts that gather the following information from the victim machine:

Network configuration;

System architecture, e.g.×86, ALPHA, SPARC, PPC; and

Media device configuration, e.g. how many hard drives.

The scripts are preferably CGI (common gateway interface) scripts. CGI is a standard for running external programs from a World-Wide Web HTTP server. CGI specifies how to pass arguments to the executing program as part of the HTTP request. It also defines a set of environment variables. Commonly, the program generates some HTML which is passed back to a browser, but it can also request URL redirection. CGI allows the returned HTML (or other document type) to depend in any arbitrary way on the request. The CGI program can, for example, access information in a database and format the results as HTML. A CGI program can be any program which can accept command line arguments. Perl is a common choice for writing CGI scripts. Some HTTP servers require CGI programs to reside in a special directory, often “/cgi-bin” but other servers provide ways to distinguish CGI programs so they can be kept in the same directories as the HTML files to which they are related. Whenever the server receives a CGI execution request it creates a new process to run the external program. If the process fails to terminate for some reason, or if requests are received faster than the server can respond to them, the server may become swamped with processes.

In the invention, the CGI scripts take the information concerning the victim machine and generate a bootable image from the appropriate machine kernel. The scripts also generate a one-use certificate for authentication and authorization that allows a single connection to the evidence aggregation server.

The forensic evidence aggregator is a custom implementation of an SSL server that restricts connections based upon verification of a certificate by a trusted third party authority, such as Verisign and the system also uses the tcp handshake for authentication (Tcp handshake=syn-ack-syn). Only 1 IP address is allowed to connect at a time. This is commonly referred to as wrapping a service. The forensic evidence aggregator provides multiple disk support, such that each host has it's own physical disk that is stored separately, where each such disk has it's own chain of custody.

Process Overview

In operation, an incident response team is contacted by a client that suspects a security incident has occurred.

The client provides the following information to the incident response team:

System architecture for the victim machine/s;

Network configuration of the victim machine/s, as well as access control devices on the network, e.g. firewall configurations; and

Why an incident is suspected.

The incident response team enters relevant data into a CGI template, i.e. a script as discussed above. The script then generates an appropriate kernel image for the client machine 10 along with a client folder on the Evidence aggregation server. This is where the data are stored, where the data are information about the victim machine. A partition on the evidence aggregation server is also created. The client is also provided orally with a one-time password.

The client then connects to the signing authority Web site with the one-time password and downloads the kernel boot image onto a storage medium, such as a floppy disk. The disk image is encrypted using an encryption application, such as open PGP, and the encrypted image is sent to the client 12.

The client inserts the floppy disk that contains the bootable image into the victim machine, and reboots the machine from the floppy disk 14. The victim machine is now running from the trusted kernel contained on the floppy disk and not from any possibly victim machine resources, e.g. a hacked internal drive. The boot disk mounts all media in read only mode. The kernel and tools are all loaded into the machine's RAM memory from the boot disk. The machine can then establish network connectivity. Read only mode also means that residual information in swap space can be found. This is something that very few investigators do.

Cryptographic hashes are taken of all of the essential partitions on the victim machine. The hashes are sent to the evidence aggregation server and, optionally, to a trusted third party, such as Verisign, as well as to a time stamping authority, such as Suriety.

Data are retrieved from the victim machine, streamed to the evidence aggregation server via an SSL connection, stored at the evidence aggregation server as though the server were a hard drive of the victim machine, and processed 16.

Once the image of the drive is completed, another cryptographic hash is taken of the data on the evidence aggregation server and compared with the original hashes. If they match, a secured email is sent by the evidence aggregation server to notify the incident response team that the process has completed successfully. They derive on the evidence aggregation server can then be removed and remitted to a chain of custody. This is all hosted in a heavily secured facility.

Thus, the invention secures the victim machine by running the machine from a boot disk, such that the state of all machine resources remains unchanged from the time the incident was first reported. The boot disk operates the victim machine to produce a hash of all relevant machine resources which is sent to a trusted authority, and then streams the contents of these resources to a remote location where they are securely stored. Once this information is captured at the remote location, a second hash is performed and the second and first hashes are compared to determine whether or not the captured information is a true representation of the information on the victim machine.

If a match is determined, then the remote copy of the information is passed through a chain of custody that securely retains its authenticity.

The forensic disk image contains the following:

1. A bootable kernel that is selected for the victim machine from multiple machine architectures. The requirements for the kernel are that it provide support for TCP/IP networking and multiple hard drive configurations. Support for RAID arrays and other system components may also be provided.

2. The disk is protected so that it mounts in a read only mode, e.g. by permanently removing the write enable tab or other known mechanisms.

3. A message digest, such as an MD5 (MD5 is the message digest function defined in RFC 1321) checksum, is performed by software on the disk to volumes on the victim machine to be copied therefrom for remote forensic analysis. The message digest creates a unique and non-reputable identifier for the data to be copied for a third party signing authority, such as Verisign.

4. NNTP (Network News Transport Protocol, see RFC 977) synchronizes the system clock of the victim machine so that time stamps are accurate.

5. A one time use SSL certificate is signed by a trusted authority 24, 28, e.g. Verisign. The certificate limits the connection available from the victim machine to a single session with the evidence aggregation server. If the connection fails during the disk image process, a new disk image must be generated. Then the process starts again. Note: SSL refers to Secure Socket Layer: A protocol designed by Netscape Communications Corporation to provide encrypted communications on the Internet. SSL is layered beneath application protocols such as HTTP, SMTP, Telnet, FTP, Gopher, and NNTP and is layered above the connection protocol TCP/IP. It is used by the HTTPS access method.

6. The contents of the victim machine are copied over a secure channel that is good for one use only 16 using disk imaging software, such as dd (Note: dd is a Unix copy command with special options suitable for block-oriented devices).

How the forensic disk image works:

1. The image boots and loads into RAM only. The swap space/pagefile is not touched so that residual evidence in memory is preserved.

2. Media devices are detected in a read only mode.

3. Network support is brought up. No services are turned on, so the machine is secure.

4. NNTP synchronizes system time to an NNTP server on a server machine. The server is synchronized via a remote NNTP server.

5. An SSL connection is established to a secure server in an exodus vault.

6. A message digest, e.g. MD5 checksum, is written across the secure connection to a disk on the secure server 24. Timestamps are also taken and written to the disk on the secure server.

7. A dd starts running and takes a bit by bit image of the victim machine 16. Rather than writing to a local media, the dd sends it's output over the SSL connection to the disk on the secure server 18.

8. Once the dd has completed, the disk ejects itself and powers off the victim machine.

9. The disk on the secure server is removed and a chain of custody is created 22.

10. The evidence is stored in a secure location 20.

How the server is set up:

1. The server is locked down. A stripped version of the operating system, e.g. BSD Unix, is used that has nothing other than network and disk support enabled. This allows for the removal of suid (Set User ID=If Setuid=Root then the file/program can be run by any user with roots privileges) binaries that could be exploited or used to overwrite data.

2. The SSL connections are wrapped using three authentication mechanisms:

Firewall access controls;

Host TCP wrappers; and

One time SSL certificates—mod_ssl implementation.

3. Multiple disk support is enabled so that each client can have a partition (/home/client for example) that maps to a removable physical device 18.

4. The Web server has a CGI front end that is used over SSL. The CGI front end ties into a script that generates the appropriate disk image, and does an MD5 hash on it. The script also creates a home directory for the client machine that maps to it's own disk. For example, /home/client maps to /dev/hda8, which is for example a detachable SCSI disk.

5. The server has two interfaces. One interface has a publicly available IP address that listens for connections from the forensic evidence aggregator. The other interface is a private link used for such purposes as administration.

Although the invention is described herein with reference to the preferred embodiment, one skilled in the art will readily appreciate that other applications may be substituted for those set forth herein without departing from the spirit and scope of the present invention. Accordingly, the invention should only be limited by the claims included below.

1. A remote computer forensic evidence collection apparatus, comprising:
a mechanism for remotely collecting client data while adhering to strict evidentiary standards; and
a mechanism for automatically verifying content received from a victim machine with data from said victim machine.

2. The apparatus of claim 1, said system comprising:
a forensic evidence aggregator;
an image generation system; and
a bootable image containing a forensic evidence collection suite.

3. The apparatus of claim 2, wherein said image generation system comprises:
a set of scripts that gather any of the following information from said victim machine:
network configuration; system architecture; and media device configuration.

4. The apparatus of claim 2, wherein said image generation system comprises:
a set of scripts that take information concerning said victim machine and generate a bootable image for said victim machine from an appropriate machine kernel.

5. The apparatus of claim 2, wherein said image generation system comprises:
a set of scripts that generate a one-use certificate for authentication and authorization that allows a single connection to said evidence aggregation server from said victim machine.

6. The apparatus of claim 2, wherein said forensic evidence aggregator comprises:
an SSL server that restricts connections based upon verification of a certificate by a trusted third party authority.

7. The apparatus of claim 2, wherein said forensic evidence aggregator comprises:
a server that provides multiple disk support, such that each host has it's own physical disk that is stored separately, where each such disk has it's own chain of custody.

8. A remote computer forensic evidence collection method, comprising the steps of:
a client contacting an incident response team when a security incident is suspected to have occurred, wherein said incident response team is provided with any of the following information:
system architecture for a victim machine;
network configuration of said victim machine;
access control devices on a network to which the victim machine is connected; and
why an incident is suspected;
said incident response team entering relevant data into a script to generate a kernel boot image for said victim machine;
said incident response team providing said client with a one-time password;
said client accessing an on-line signing authority with said one-time password and downloading said kernel boot image onto a storage medium, wherein said kernel boot image is encrypted using an encryption application and an encrypted version of said kernel boot image is sent to said client;
said client rebooting said victim machine using said kernel boot image on said storage medium, wherein all media associated with said victim machine are mounted in read only mode and wherein said victim machine can establish network connectivity;
taking a first cryptographic hash of all of essential partitions on said victim machine;
sending said cryptographic hashes to an evidence aggregation server and, optionally, to any of a trusted third party and a time stamping authority;
retrieving data from said victim machine and streaming said data to said evidence aggregation server via a secure connection;
storing said data at said evidence aggregation server on a partitioned, separable storage medium;
once streaming of an image of said victim machine data to said evidence aggregation server is completed, taking a cryptographic hash of said data on said evidence aggregation server and comparing said cryptographic hash with said first cryptographic hash; wherein if said cryptographic hashes match, a secured email is sent by said evidence aggregation server indicating that an image of said victim machine has been captured has captured successfully; and
removing said separable storage medium from said evidence aggregation server and remitting said separable storage medium to a chain of custody.

9. A method for securing a victim machine, comprising the steps of:
running said victim machine from a secure boot disk, such that a state of all machine resources remains unchanged from a time an incident is first reported;
said secure boot disk operating said victim machine to produce a first hash of said victim machine contents, wherein said hash is sent to a trusted authority;
said victim machine streaming said victim machine contents to a remote location where they are securely stored;
once said victim machine contents are captured at said remote location, performing a second hash of said victim machine contents as received at said remote location and comparing said second and said first hashes to determine whether or not said captured victim machine contents provide a true representation of said victim machine contents;
wherein if a match is determined, then passing said victim machine contents captured at said remote location through a chain of custody that securely retains its authenticity.

10. A forensic disk image, comprising:
a bootable kernel that is selected for a victim machine from multiple machine architectures to provide support for networking and multiple drive configurations, wherein said disk image is protected so that it mounts in a read only mode;
a message digest function to be performed by software on said disk image to volumes on said victim machine to be copied therefrom for remote forensic analysis, wherein message digest creates a unique and non-reputable identifier for data to be copied for a third party signing authority;
an optional mechanism for synchronizing a system clock of said victim machine so that time stamps are accurate;
a one time use certificate signed by a trusted authority for limiting a connection available from said victim machine to a single session with an evidence aggregation server; and
a mechanism for copying contents of said victim machine over a secure channel to said evidence aggregation server.

11. A method for operating a forensic disk image, comprising the steps of:
booting and loading said disk image only into RAM of a victim machine;
detecting media devices in a read only mode;
bringing up network support, wherein no services are turned on, so said victim machine is secure;
optionally synchronizing victim machine system time to an NNTP server;
establishing a secure connection to a secure server;
writing a message digest across said secure connection to a partitioned, separable storage medium on a secure server;
optionally taking timestamps and writing said timestamps to said separable storage medium on said secure server;
taking an image of said victim machine and sending said image over said secure connection to said separable storage medium on said secure server.

12. The method of claim 11, wherein a medium containing said disk image is ejected from said victim machine and said victim machines is powered off, once sending of said victim machine image to said secure server is completed.

13. The method of claim 11, wherein said separable storage medium on said secure server is removed from said secure server and a chain of custody is created, once sending of said victim machine image to said secure server is completed.
